(19) United States
(12) Patent Application Publication
(10) Pub. No.: US 2026/0236362 A1
(43) Pub. Date: Aug. 13, 2026

(54) Systems and Methods Providing Built-In Self-Test Corrective Action During Runtime

(71) Applicant: TEXAS INSTRUMENTS INCORPORATED, Dallas, TX (US)

(72) Inventors: Vishal Diwan, Bangalore (IN); Mihir Narendra Mody, Bangalore (IN); Saravanan Gajendran, Bangalore (IN)

(21) Appl. No.: 19/051,417

(22) Filed: Feb. 12, 2025

(51) Int. Cl. G06F 11/27

(52) U.S. Cl. CPC G06F 11/27

(57) ABSTRACT

A computer system includes functionality to provide built-in self-test (BIST) management and corrective action during runtime. A computer system may include multiple processor cores, where at least one of those processor cores is dedicated to running BIST management software and correction software. During runtime of an application on a processor core, the other processor core that is dedicated to running BIST management software and correction software, may cause BIST operations to be performed and may then perform corrective actions in response to results of the BIST operations.

### TECHNICAL FIELD

The present disclosure relates generally to computer systems and, more specifically, to systems and methods for providing built in self-test (BIST) corrective action during runtime in computer systems.

### BACKGROUND

Safety protocols are used to ensure safety in electrical and/or electronic systems. For example, International Organization for Standardization (ISO) 26262 is an international standard for functional safety of electrical and/or electronic systems in automobiles. Such safety protocols analyze risk (e.g., the combination of the frequency of occurrence of harm and the severity of that harm) associated with electronic failures. Failures corresponding to electronics may be random or systematic. Random failures may correspond to hardware related permanent or transient failures due to a system component loss of functionality. Systematic failures may correspond to design faults, incorrect specifications, and/or not fit for purpose errors in software. Such safety protocols may analyze the electrical risks associated with a hardware component that may handle a signal to improve vehicle safety.

### SUMMARY

In an arrangement, a method includes: executing computer-executable code for a first application, wherein the first application includes receiving data from a hardware component of a computer system on which the first application runs; during runtime of the first application, executing computer-executable code for a second application that causes a built-in self-test (BIST) operation to run on the hardware component; and performing, by the second application and during runtime of the first application, a corrective action upon the hardware component based on results of the BIST operation.

In another arrangement, a system includes: a first processor core; a second processor core; and a real-time address translation (RAT) circuit, coupled between the second processor core and a random-access memory (RAM), wherein the RAT circuit is configured to translate addresses of the RAM in transactions from the second processor core; wherein the first processor core is configured to change a setting of the RAT circuit, via a hardware signal, to configure translation of addresses by the RAT circuit during runtime of an application by the second processor core.

In another arrangement, an integrated circuit (IC) includes: a first processor core; a second processor core; a hardware module coupled to the first processor core and configured to transmit data to the first processor core during runtime of a first application, which is run on the first processor core; and a tightly coupled memory (TCM) circuit, disposed within the second processor core and configured to store computer-executable code for built-in self-test (BIST) management software, wherein the BIST management software is configured to cause a BIST operation to run on the hardware module during runtime of the first application.

### BRIEF DESCRIPTION OF THE DRAWINGS

Having thus described the invention in general terms, reference will now be made to the accompanying drawings, wherein:

FIG. 1 is an illustration of an example system, according to some embodiments.

FIG. 2 is an illustration of an example architecture, which may be used for a processor core to run safety software, according to some embodiments.

FIG. 3 is an illustration of an example architecture for a real time address translation circuit, according to some embodiments.

FIG. 4 is an illustration of an example method, which may be performed by a processor core as it runs safety software, according to some embodiments.

FIG. 5 is an illustration of an example method, which may be performed by safety software, according to some embodiments.

FIG. 6 is an illustration of an example method, which may be performed by safety software, according to some embodiments.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Automotive Safety Integrity Level (ASIL) falls under the umbrella of ISO 26262, and it specifies safety levels of automotive components. ASIL compliance may require systems to have high levels of failure detection. An example of failure detection may include built-in self-test (BIST), where hardware testing modules (e.g., BIST modules) may run tests on other hardware modules (e.g., memory circuits, analog-to-digital converters). In the context of ASIL, BIST operations may be referred to as safety or functional safety.

Various embodiments may include systems and methods that allow for BIST operations and corrections during runtime. Some embodiments may also include a separate processor core (or multiple processor cores) for BIST management and corrections, thereby allowing other processor cores to run applications without a reduction in application performance.

In one example a method includes executing computer-executable code for a first application. The first application may include functionality for an industrial or automotive use. For instance, various levels of ASIL may be directed toward systems in which failure may cause injury, such as in industrial machines, automobile airbag systems, automatic braking systems, and the like. The first application may provide such functionality, where it may be desirable or even required by law to reduce failures (e.g., malfunctions) and to discover failures before they cause injury.

Further in this example, the first application may run on a first processor core. The first application may include receiving data from a hardware component, such as a memory circuit (e.g., SRAM, DRAM), an analog-to-digital converter (ADC), digital logic (e.g., sequential logic, logic gates), and/or the like.

Continuing with the example, during runtime of the first application, another processor core may execute computer-executable code for a second application. The second application may provide BIST management and correction functionality. For instance, the second application may cause a BIST operation to run on the hardware component. In an example use case, the second application may transmit hardware signals, or use another technique, to cause a BIST circuit to perform a BIST operation on the hardware component and to return the results of the BIST operation to the second application running on the second processor core.

After having received the results of the BIST operation, the second application may then perform a corrective action upon the hardware component in response to the results of the BIST operation. One example of corrective action that may be performed includes configuring a real-time address translation circuit of the first processor core to avoid portions of memory that are indicated as malfunctioning by the BIST operation. Another example includes performing a trimming operation for a calibration operation on an ADC in response to the BIST results indicating a malfunction on the ADC. Yet another example includes reducing a resolution level or a sampling rate of the ADC in response to the BIST results.

In some implementations, the corrective action may result in a decrease in some characteristic of performance of the first application, while allowing the first application to continue running. For instance, reducing a sampling rate of the ADC or a resolution level of the ADC may be accompanied by some reduction in performance of the first application, though the first application may still be able to provide acceptable performance. Such a mode may be referred to as limp mode in some examples.

Various embodiments may provide advantages over other solutions. For instance, some systems may provide BIST operations during runtime, but they may not provide corrective action in response to the results of the BIST operations. In such instances, the safety application on the chip may simply render the system nonoperational. By contrast, various embodiments may allow for the first application to continue operation, thereby allowing for further use of the system.

Another advantage may include separating execution of the BIST management and corrections software from the other application execution. For instance, some embodiments may exclude main application processor cores from running the BIST management and corrections software, instead segregating the BIST management and corrections software to a separate processor core or cores. Such an architecture may allow for execution of a main application without having to compete for processor capacity with the BIST management and corrections software. In other words, such an architecture may allow for faster processing for the main application.

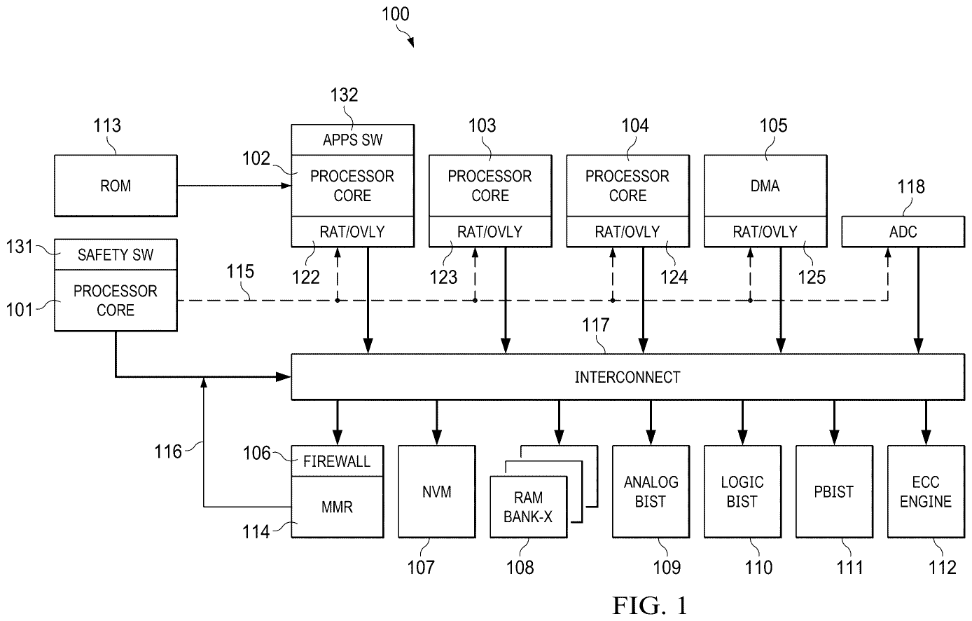

FIG. 1 is an illustration of example system 100, according to some embodiments. Example system 100 may be implemented as one or more integrated circuits. For instance, each of the components 101-118 may be included on a same semiconductor die, with additional components (not shown), as a system on chip (SoC). In another example, the processor cores 101-104 may be implemented on a semiconductor die, and the interconnect 117 and memory devices 107, 108 may be implemented on one or more other semiconductor dies. One or more given semiconductor dies may be included within a semiconductor package, and that package may be mounted to a printed circuit board or other component.

Furthermore, while FIG. 1 shows four processor cores 101-104, the scope of implementations may include a system having more or fewer processor cores. Also, the quantity of interconnects (e.g., 117), memory devices (e.g., 107, 108), and peripheral devices (e.g., 118) may be scaled as appropriate to accommodate any appropriate number and type of memory devices and/or peripheral devices.

Each processor core 101-104 may include any appropriate processor core according to any appropriate processor architecture. For instance, a given processor core may be implemented as a general-purpose processor core, a special-purpose processor, a reduced instruction set computer, a graphics processing unit, or other processor core.

In the present example, processor core 102 may be used as a main central processing unit (CPU) and may be configured to execute main application 132. For instance, main application 132 may include computer executable code, which performs specific functions for an automobile, an industrial machine, or other use case, where performance of the function may be subject to regulations. As noted above, industrial machine operation, braking systems, airbag deployment systems, steering systems, and the like may be use cases for the main application 132.

Further in the present example, read-only memory (ROM) 113 may include a basic input output system (BIOS) or other boot software, which may be read and executed by processor core 102 at boot time. Once booted, processor core 102 may then read and execute computer executable code from a nonvolatile memory (NVM) 107. For instance, NVM 107 may store code implementing an operating system (OS), one or more applications (e.g., main application 132), and/or the like. Random-access memory (RAM) circuit 108 in this example may include multi-bank RAM or other appropriate memory circuit for use by processor cores 101-104 during runtime. Direct memory access (DMA) circuit 105 may be employed by any of the processor cores 101-104 to read or write computer executable code and/or data to NVM 107 and/or RAM 108.

Interconnect 117 may include a bus or other appropriate set of conductors as well as a bus controller (not shown), which may operate according to any appropriate protocol. In the present example, each of the processor cores 101-104, may communicate with each other and with any of the other components 105-112, 118 via interconnect 117.

Analog-to-digital converter (ADC) 118 may receive analog information from on-chip or off-chip and may convert that analog information to digital data. For instance, ADC 118 may convert analog input to digital data and then provide that digital data to another component (e.g., processor core 102) via interconnect 117. ECC engine 112 may perform error correction code (ECC) operations to support any of the various components of system 100.

Firewall circuit 106 may be configured to perform the functions of an access management circuit. For instance, firewall circuit 106 may include hardware logic that is configured to assign priority access levels to any one of the various components and the processor cores 101-104 and to enforce the priority access levels. For instance, enforcing the priority access levels may include allowing or disallowing a communication or action based upon a priority access level. Each of the different processor cores 101-104 and the other components of system 100 may include hardware logic (not shown), which is configured to work with firewall circuit 106 so that the firewall circuit 106 may manage assigned priority access levels and enforce the priority access levels. Firewall circuit 106 may include memory mapped registers (MMR) 114, to which the firewall circuit 106 may write and access data indicating priority access levels. Firewall circuit 106 may communicate with other components of system 100 via interconnect 117 and may also communicate with processor core 101 via a hardware signal on conductor 116.

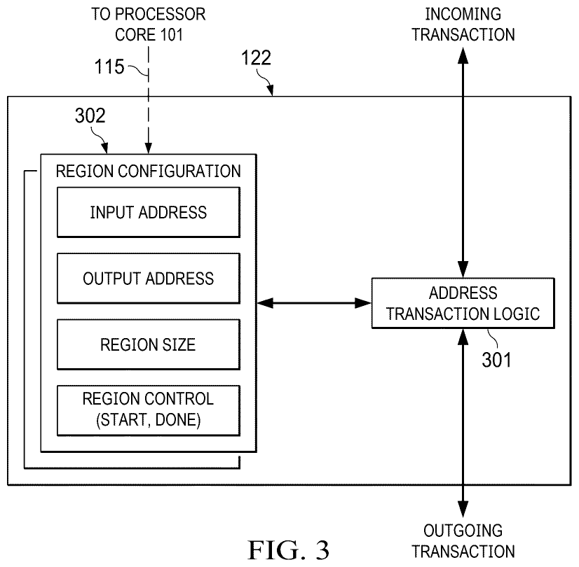

Conductor 115 represents a conductor, which is separate from interconnect 117, and which may conduct hardware signals (e.g., sideband signals) from the processor core 101 to the real time address translation (RAT) and overlay (OVLY) (hereinafter, RAT) circuits 122-125. As will be explained below with respect to FIG. 3, the processor core 101 may configure each one of the RAT circuits 122-125 based on results of BIST operations.

BIST circuits 109-111 may include hardware or firmware logic to perform BIST operations on various components of the system 100.

In this example, processor core 101 is configured to execute computer executable code to perform the functions of safety software 131. Safety software 131 may include BIST management and corrections, as described in more detail below. For instance, safety software 131 may manage start and stop times of the BIST components 109-111, may receive results of BIST operations from BIST components 109-111 (via interconnect 117), may analyze the results of the BIST operations, and may perform corrective actions in response to the results of the BIST operations.

Various implementations may use any appropriate BIST operation. In one example, PBIST circuit 111 may perform a BIST operation on memory devices, such as RAM circuit 108. For instance, the PBIST circuit 111 may have test pattern generation functionality, which may generate a pattern of digital bits and apply that pattern to a circuit under test (e.g., RAM circuit 108) via interconnect 117. For purposes of testing the RAM circuit 108, the RAM circuit 108 may receive the pattern of bits as part of a write operation, where it may write that pattern of bits into one or more memory addresses and then may read out that pattern of bits back to PBIST circuit 111. PBIST circuit 111 may then compare the data that was read out from RAM circuit 108 to the known test pattern and may then provide the test results to the safety software 131.

In another example, logic BIST 110 may be used to test flip-flops or other combinational logic, which may exist in any of the various components, such as in any of the processor cores 101-104, DMA circuit 105, interconnect 117, and/or the like. For instance, logic BIST 110 may use test patterns or other appropriate tests to write data to combinational logic and then to receive that data back from the combinational logic under test. Logic BIST 110 may then compare the data received to the test pattern and then provide the results of the test to safety software 131.

In another example, analog BIST 109 may perform BIST operations on analog circuitry, such as ADC 118, a digital to analog converter (DAC, not shown), or other peripherals that may have analog circuitry. In an example in which ADC 118 is a circuit under test, analog BIST 109 may transmit a ramp signal or other appropriate signal to ADC 118 and then receive digital output from ADC 118. Analog BIST circuit 109 may compare the output of the ADC 118 to an expected correct output and may then transmit the results of the test to safety software 131.

Safety software 131 may be configured to cause the BIST circuits 109-111 to perform BIST operations periodically or as requested. In some examples, safety software 131 may be configured to cause BIST operations to be performed multiple times every second during runtime of main application 132. Safety software 131 may receive the results of the BIST operations and then perform corrective action as appropriate.

In the present example, processor core 101 runs the safety software and does not run the main application 132. In other words, in this example, execution of the safety software 131 is segregated to processor core 101, and execution of other applications may be segregated to any one or more of processor cores 102-104. In this way, execution of the safety software 131 may not take away from the processing capacity of the other processor cores 102-104. Also, while the example of FIG. 1 only shows a single application 132 being run on processor core 102, it is understood that various embodiments may run any appropriate quantity of applications on any of the processor cores 102-104 concurrently.

Furthermore, various implementations may allow for the safety software 131 to perform corrective actions based on results of the BIST operations, as described in more detail with respect to FIGS. 3-6.

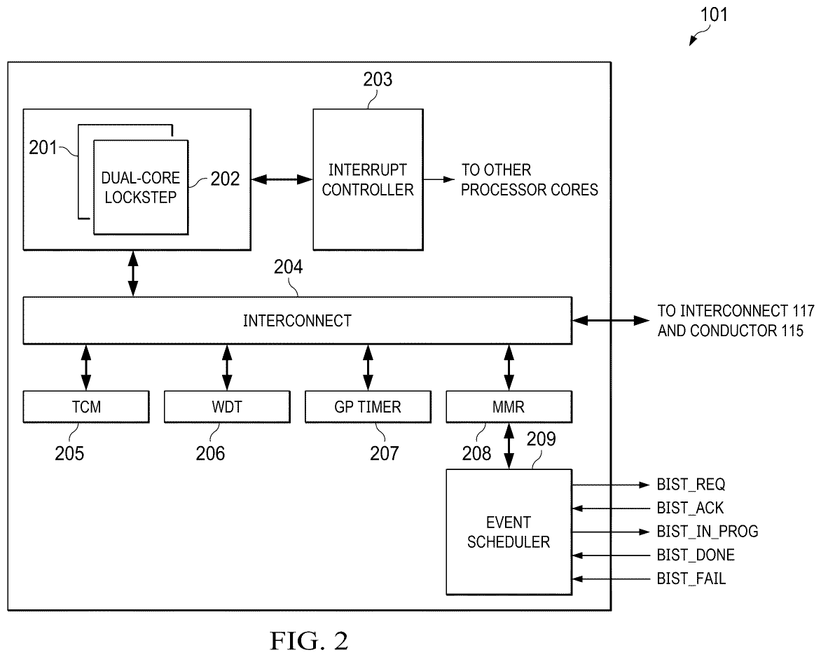

FIG. 2 is an illustration of an example architecture, which may be used for processor core 101 of FIG. 1, according to some embodiments. In this example, processor core 101 includes a dual-core lockstep component, illustrated by two separate cores 201-202. For instance, the cores 201-202 may have the same or similar hardware circuitry and may execute the same computer executable code at each clock cycle. Furthermore, the cores 201-202 may have functionality to check the output of each of the cores 201-202 to confirm that each of the cores 201-202 is performing correctly. In some use cases, dual-core lockstep architectures may be required by regulations, standards bodies, or contracts. However, the concepts of the present disclosure may be adapted to use in a processor core which has only a single core or has more than two cores.

Each of the cores 201-202 may have less functionality than a general-purpose processor or a digital signal processor. For instance, each of the cores 201-202 may be a reduced instruction set computer and may even in some instances be a reduced functionality version of a reduced instruction set computer. However, the scope of implementations may be adapted for use of any appropriate processor core as processor core 101.

In the present example, each of the cores 201-202 may separately execute code to provide the functionality of safety software 131. Interconnect 204 may include conductors and logic to communicatively couple cores 201-202 to the other components. For instance, tightly coupled memory (TCM) 205 may be configured to be accessible only by processor core 101 and not by the other cores 102-104 of FIG. 1, at least during runtime. In some examples, at boot time, processor core 101 may read computer executable code from memory circuit 107 and then load that code to TCM 205. Processor core 101 (e.g., cores 201-202) may then access the computer executable code from TCM 205 to run the safety software 131.

During runtime of the safety software 131, the safety software 131 may cause the processor core 101 to access the general-purpose timer 207, where the safety software 131 may use the general-purpose timer 207 to time BIST operations by the BIST circuits 109-111. The safety software 131 may use watchdog timer 206 to confirm that a BIST operation has not exceeded a timeout time or that a time between BIST operations has not exceeded a timeout time.

The MMR circuit 208 may be configured to store the BIST operation results, failure codes for comparison with BIST operation results, and state of components (operable, idle), and/or the like. The MMR circuit 208 may include memory addresses that may be mapped for use by cores 201-202 as well as by the other cores 102-104 of system 100.

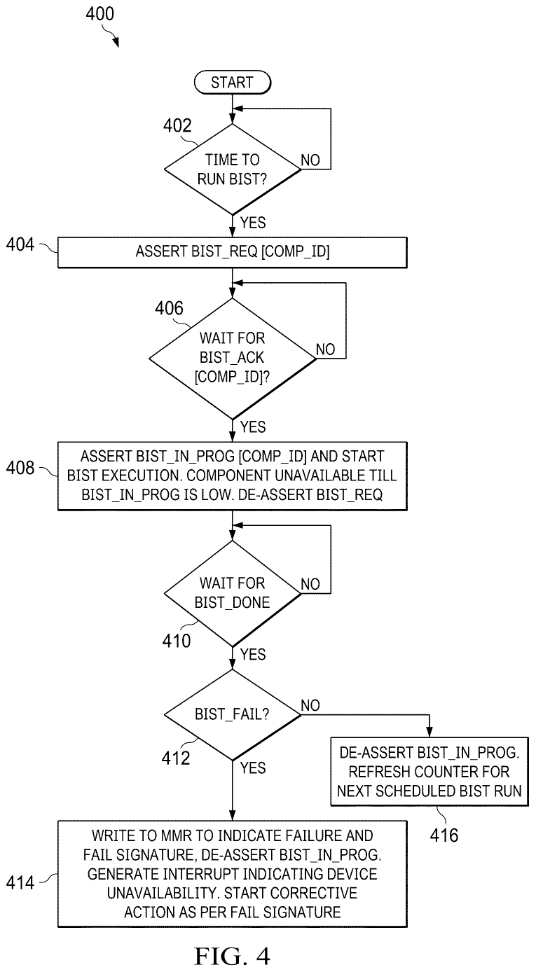

Event scheduler 209 may include hardware or firmware logic, which may read to and write from MMR circuit 208 and which also may transmit and receive control signals (e.g., BIST_REQ) to manage BIST operations. In other words, the safety software 131 may be configured to use the event scheduler 209 to transmit signals to the BIST circuits 109-111 to start BIST operations, stop BIST operations, and to receive signals from the BIST circuits 109-111. The control signals are described in more detail with respect to FIGS. 4-6.

The event scheduler 209 may communicate with the BIST circuits 109-111 via interconnect 204 and interconnect 117 and/or on conductors separate from interconnect 204 and interconnect 117. Processor core 101 also includes interrupt controller 203, which may be configured to be in communication with the other processor cores 102-104. For instance, upon encountering BIST operation results, the safety software 131 may generate an interrupt for one or more of the other processor cores 102-104. The interrupt controller 203 may be in communication with the other processor cores 102-104 via interconnects 204 and 117 or through some other conductor, as appropriate.

FIG. 3 is an illustration of an example architecture for RAT circuit 122 of FIG. 1, according to some embodiments. Furthermore, while the description of FIG. 3 is directed toward RAT circuit 122, it is understood that the architecture and operation may be adapted for use in any RAT circuit, such as any of 122-125 of FIG. 1.

RAT circuit 122 may be configured to intercept transactions to and from processor core 102 so that address translation logic 301 may parse the address data and, if appropriate, change that address data based on one or more region configurations 302. The RAT circuit 122 may translate addresses destined for RAM circuit 108, NVM 107, memory-mapped peripherals, and other destinations within or coupled to system 100. In one example use case, the safety software 131 may determine that a particular range of addresses within RAM circuit 108 is defective. In response, the safety software 131 may set up a region configuration 302, which is configured to cause addresses to be changed from defective addresses to addresses specified in the region configuration 302.

For instance, if safety software 131 determines that an address range AAAA-BBBB is defective within RAM circuit 108, then safety software 131 may determine to use another range of addresses within RAM circuit 108, such as address range CCCC-DDDD. The safety software 131 may use sideband signals on conductor 115 to write to region configuration 302. The input address field may identify the malfunctioning address range by its starting address AAAA, the output address field may identify the substituted address range by its starting address CCCC, and the region size field may identify a size of the substituted address range or a size of the malfunctioning address range. In other words, a starting address plus a region size may yield an address range. The region control field may specify whether the region configuration 302 is active and available for use.

The address translation logic 301 may receive an address on an incoming transaction from processor core 102, where that address may be associated with a read operation, a write operation, or some other appropriate operation. The address translation logic 301 may parse that incoming transaction, determine whether address data of the transaction refers to the malfunctioning address range. If the address data of the transaction does not refer to the malfunctioning address range, then the address translation logic 301 may output the transaction as an outgoing transaction without change to the address data. However, if the address data of the transaction does refer to the malfunctioning address range, then the address translation logic 301 may output the transaction as an outgoing transaction with the address data changed to an address within the substituted address range.

Although FIG. 3 shows only one region configuration 302, it is understood that a given RAT circuit 122-125 may include any appropriate number of region configurations, where some may be active or inactive. Furthermore, the safety software 131, which runs on the processor core 101, may configure region configuration 302 in response to BIST operation results. In one example, the safety software 131 may request access from the firewall circuit 106 to write to region configuration 302. The firewall circuit 106 may include hardware logic configured to allow the processor core 101 to write to RAT circuit 122 when appropriate. Accordingly, the firewall circuit 106 may then change a priority access status of processor core 101 so that processor core 101 is allowed to write to RAT circuit 122. For instance, the firewall circuit 106 may include a grant of permission as data within MMR circuit 114 and allow access to MMR circuit 114 via conductor 116. Any of the processor cores 101-104 and DMA circuit 105 may be able to read the contents of MMR circuit 114 to determine that processor core 101 has priority access to write to a given one of the RAT circuits 122-125.

Assuming that processor core 101 is granted priority access to write to RAT circuit 122, then safety software 131 may then write to the fields of region configuration 302 (or some other region configuration, not shown) to identify a malfunctioning address range and identify a substitute address range. As noted above, in some examples, conductor 115 may be separate from interconnect 117 and may carry sideband signals. In other words, processor core 101 may use sideband signals, rather than in-band signals, to write to the fields in a region configuration. Nevertheless, other implementations may use any appropriate technique for configuring a region configuration.

FIG. 4 is an illustration of an example method 400, which may be performed by processor core 101 as it runs safety software 131, according to some embodiments. Method 400 is an example method that applies to a single BIST operation. It is understood that method 400 may be performed for each appropriate BIST operation in system 100. For instance, for a particular BIST operation to be performed by analog BIST circuit 109, safety software 131 may perform an instantiation of method 400, and for a particular BIST operation to be performed by PBIST circuit 111, safety software 131 may perform another instantiation of method 400, and the various instantiations of method 400 may run concurrently.

At action 402, the safety software 131 may check general-purpose timer 207 to determine whether it is time to run the BIST operation. Action 402 may be performed every clock cycle, every X clock cycles where X is an appropriate integer, or at another appropriate time. Action 402 may be repeated if the value of the general-purpose timer 207 does not indicate that it is time to perform the BIST operation. If it is time to perform the BIST operation, then method 400 moves to action 404, where the event scheduler 209 asserts the BIST_REQ signal on interconnect 117. In this example, the BIST_REQ signal includes an identifier [comp_id], which identifies the particular component that will be a component under test for the BIST operation.

The other processor cores 102-104 and DMA circuit 105 may receive the signal on interconnect 117 and may then reply with an acknowledgment signal, BIST_ACK[comp_id], which is received by the event scheduler 209. Each of the processor cores 102-105 and DMA circuit 105 may, having received the BIST_REQ, execute any portions of code that require use of the identified component before replying with the acknowledgment signal.

Once the appropriate acknowledgment signals have been received, the safety software 131 may then use the event scheduler 209 to assert the BIST_IN_PRG[comp_id] signal on the interconnect 117 at action 408. As long as the BIST_IN_PRG[comp_id] signal is high, then the other processor cores 102-104 and DMA circuit 105 are configured to treat the identified component as unavailable. Action 408 may also include de-asserting the BIST_REQ signal. In some examples, action 408 may also include the safety software 131 writing a device status (e.g., idle) to the MMR circuit 208 to indicate that the particular component is unavailable.

The BIST circuits 109-111 may be configured to parse the BIST signals from the event scheduler 209 and to run a BIST operation when appropriate. For instance, if the BIST_IN_PRG[comp_id] signal identifies ADC 118, then the analog BIST circuit 109 may be configured to begin a BIST operation for the ADC 118 upon receipt of that signal. Similarly, the other BIST circuits 110-111 may be configured to ignore the BIST_IN_PRG[comp_id] signal if it identifies a component not testable by that BIST circuit. If the BIST_IN_PRG[comp_id] signal identifies the RAM circuit 108, then the PBIST circuit 111 may be configured to begin a BIST operation upon receipt of the signal, whereas the other BIST circuits 109-110 may be configured to ignore the signal. BIST_IN_PRG[comp_id] signal identifies combinational logic, then the logic BIST 110 may be configured to begin a BIST operation on the identified component, whereas the other BIST circuits 109 and 111 may be configured to ignore the signal.

In this example, the appropriate BIST circuit 109, 110, or 111 may then perform a BIST operation on the identified component, as safety software 131 waits for the BIST_DONE signal to be received by the event scheduler 209 at action 410. Once the appropriate BIST circuit has completed the BIST operation, then it may assert the BIST_DONE signal, which is received by the event scheduler 209.

In this example, each of the BIST circuits 109-111 may be configured to generate a BIST_FAIL signal in response to a component failing a BIST operation. On the other hand, each of the BIST circuits 109-111 may be configured to indicate that a component has successfully passed a BIST operation by asserting the BIST-DONE signal without asserting the BIST_FAIL signal.

If the safety software 131 determines that the BIST_FAIL signal has not been received at action 412, then safety software 131 may then move to action 416. At action 416, the safety software 131 causes the event scheduler 209 to de-assert the BIST_IN_PROG signal, thereby releasing the component to be used by the other processor cores 102-104 and DMA circuit 105. In some examples, action 416 may also include the safety software 131 writing a device status (e.g., operable) to the MMR circuit 208 to indicate that the particular component is available. Action 416 may also include the safety software 131 refreshing its counter for a next scheduled BIST operation.

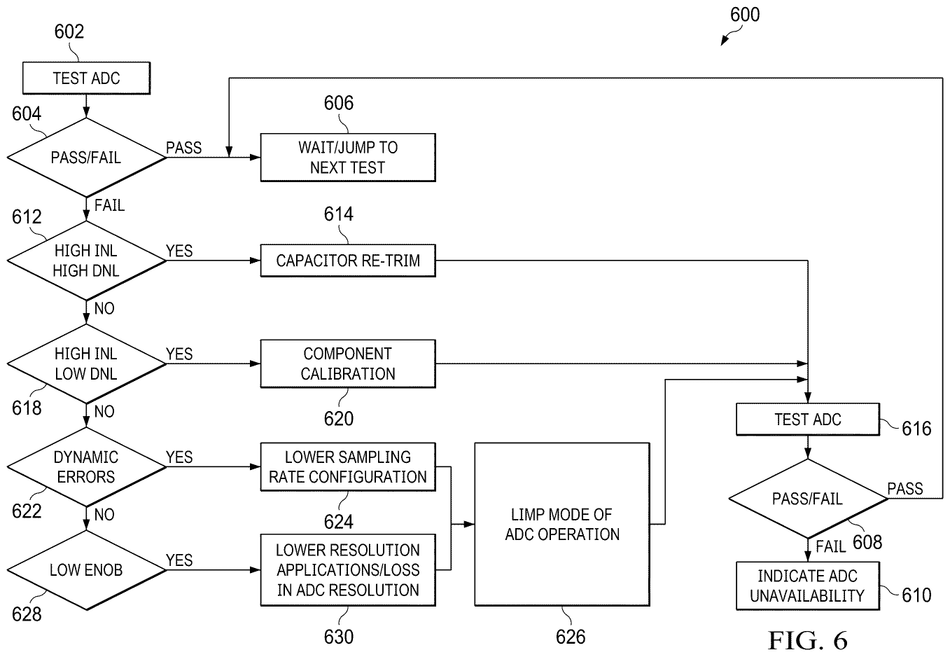

However, in this example, if the safety software 131 determines that the event scheduler 209 has received the BIST_FAIL signal at action 412, then the safety software 131 may then move to action 414. Action 414 may include the safety software 131 writing to MMR circuit 208 to indicate failure and a failure code, where a failure code may be received with the BIST_FAIL signal. The safety software 131 may also cause the event scheduler 209 to de-assert the BIST_IN_PROG signal. Furthermore, the safety software 131 may also cause the interrupt controller 203 to generate an interrupt to an appropriate one of (or all of) processor cores 102-104 and DMA circuit 105. The interrupt may indicate device unavailability for the device that failed the BIST operation. The appropriate one of (or all of) processor cores 102-104 and DMA circuit 105 may then take appropriate actions in response to receiving the interrupt. Interrupts are described in more detail with respect to FIG. 6.

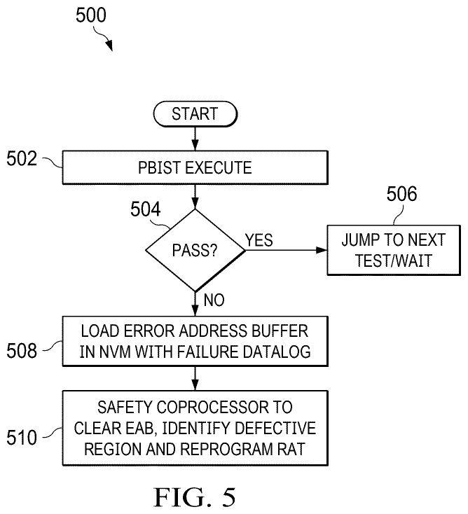

Action 414 may also include performing corrective action. For instance, the safety software 131 may compare the failure code in the BIST_FAIL signal to failure codes stored in MMR circuit 208. For instance, MMR circuit 208 may include multiple failure codes mapped to appropriate corrective actions, and the safety software 131 may use a received failure code as a key within MMR circuit 208 to determine an appropriate corrective action. Once appropriate corrective action has been completed by safety software 131, safety software 131 may then indicate availability of the component if appropriate, e.g., by writing a device status (e.g., operable) to MMR circuit 208, generating an interrupt, or other technique. Example corrective actions are described with respect to FIGS. 5-6.

FIG. 5 is an illustration of an example method 500, which may be performed by safety software 131 running on processor core 101, according to some embodiments. Method 500 illustrates an example of controlling a BIST operation to be performed on RAM circuit 108 and performing corrective action based on the BIST operation results.

At action 502, the safety software 131 may cause the PBIST circuit 111 to execute a BIST operation on RAM circuit 108. For instance, as described above with respect to method 400, the safety software 131 may cause the event scheduler 209 to issue appropriate signals and may also write an appropriate operation status (e.g., idle) to MMR circuit 208.

At action 504, the safety software 131 determines whether the RAM circuit 108 has successfully passed the BIST operation (e.g., no failures of any address ranges). For instance, in the example of method 400, receiving a BIST_DONE signal without receiving a BIST_FAIL signal may indicate that the RAM circuit 108 has successfully passed. On the other hand, receiving a BIST_FAIL signal may indicate that the RAM circuit 108 has failed (e.g., shown some malfunction of one or more address ranges).

If the safety software 131 determines that the RAM circuit 108 has successfully passed the BIST operation, then the safety software 131 may move to action 506. Action 506 may include refreshing a counter to await another BIST operation, jumping to a next test, or other appropriate action.

If the safety software 131 determines that the RAM circuit 108 has failed at action 504, then the event scheduler 209 may have received a BIST_FAIL signal with a failure code and may have stored that failure code to MMR circuit 208. The safety software 131 may then move to action 508 in response to the BIST operation results. Action 508 may include logging the BIST operation results to another component, such as memory circuit 107 or other appropriate storage device.

The safety software 131 may further move to action 510 in response to the BIST operation results indicating a malfunction or otherwise indicating a failed BIST operation. Action 510 may include the safety software 131 clearing an error address buffer (not shown) in processor core 101 and further performing corrective action. Performing corrective action may include programming an RAT circuit, such as discussed above with respect to FIG. 3. In this example, rather than performing memory repair directly on the RAM circuit 108, the safety software 131 may write to a region configuration in a RAT circuit at a processor core or DMA circuit.

Although not shown in method 500, corrective action may further include writing an appropriate component status (e.g., operable), thereby freeing system 100 to use the RAM circuit 108 as normal.

Furthermore, method 500 may include any appropriate programming for an RAT circuit, such as RAT circuit 122. For instance, the example of FIG. 3 discusses replacing a malfunctioning address range with a substitute address range of the same size. However, some embodiments may replace a malfunctioning address range or multiple malfunctioning address ranges with a block of memory or multiple blocks of memory that may be larger than the totality of the malfunctioning address ranges. For instance, one embodiment may include activating an otherwise disabled RAM bank and using that activated RAM bank for transactions that would otherwise be directed at a malfunctioning address range. Using the activated RAM bank may include programming a RAT circuit appropriately.

Moreover, the corrective action with respect to RAM circuit 108 may include treating multiple different malfunctioning address ranges differently. For instance, an address range of size X may malfunction, and an address range of size Y may also malfunction, and the safety software 131 may assign differently sized substitute address ranges as appropriate. In fact, the scope of implementations may include programming an RAT circuit in any appropriate manner to address a malfunctioning address range.

In yet another example, the safety software 131 may determine that there is not as much or more available substitute memory space as there is malfunctioning memory space. In such an example, the safety software 131 may cause the interrupt controller 203 to generate an interrupt signal to an appropriate one of (or all of) processor cores 102-104 and the DMA circuit 105. The interrupt signal may cause appropriate software or firmware to operate in a limp mode.

FIG. 6 is an illustration of example method 600, which may be performed by safety software 131 run on processor core 101, according to some embodiments. Method 600 in this example may be used to address a detected malfunction with respect to an analog component. For instance, analog BIST circuit 109 may perform a BIST operation on an ADC or a DAC or some other analog device, and method 600 illustrates how success or failure of that device may be addressed.

At action 602, the safety software 131 causes a BIST operation to be run by a BIST circuit on an analog component, in this case, an ADC. The safety software 131 may cause appropriate signals to be transmitted and received and may cause appropriate component statuses to be saved, such as described above the respect to FIG. 4.

At action 604, the safety software 131 receives results of a BIST operation and determines whether the ADC has passed or failed. For instance, as described above with respect to FIG. 4, a BIST_FAIL signal may indicate a malfunction and may be accompanied by a failure code. On the other hand, a BIST_DONE signal without a BIST_FAIL may indicate that the component has successfully passed (e.g., no malfunction).

Assuming that the component has passed, then the safety software 131 may move to action 606, which may include waiting or jumping to a next BIST operation, such as returning to action 602 or performing a different BIST operation. On the other hand, if the safety software 131 determines that the component has failed at action 604, then the safety software 131 may move to one or more of actions 612, 618, 622, or 628. In one example, the actions 612, 618, 622, and 628 represent failure codes, which may be stored in MMR circuit 208 and searched by safety software 131 using a received failure code as a search term or key. Continuing with the example, each of the subsequent actions 614, 620, 624, 630, and 626 may be corrective actions, which may be associated with failure codes in the MMR circuit 208.

If the failure code corresponds to a high integral nonlinearity (INL) and high differential nonlinearity (DNL) malfunction at action 612, then the corresponding corrective action may include re-trimming a capacitor of the ADC at action 614. The safety software 131 may perform the trim operation on the capacitor and then test the ADC again at action 616.

If the failure code corresponds to a high INL and a low DNL malfunction at action 618, then the corresponding corrective action may include a calibration of some component of the ADC. For instance, the safety software 131 may perform a recalibration of a filter or low-frequency subcircuit at action 620. Once action 620 has been performed, then the safety software 131 may retest the ADC at action 616.

Action 616 may be followed by checking whether the re-test results in a successful pass or a failure (e.g., malfunction) at action 608. If the BIST results indicate a failure, then the safety software 131 may move to action 610, which may include indicating unavailability of the component under test (the ADC). The safety software 131 may indicate unavailability by, e.g., generating an interrupt by interrupt controller 203 to be received by an appropriate one of (or all of) processor cores 102-104 and the DMA circuit 105.

Returning to action 608, should the BIST operation results indicate that the component under test has passed, then safety software 131 may move to action 606.

If the failure code corresponds to a dynamic error (e.g., a bit flip that does not repeat) at action 622, then the corresponding corrective action may include re-configuring the component under test to operate at a lower sampling rate at action 624. For instance, the safety software 131 may include functionality to re-program settings of the component under test at action 624. If the failure code corresponds to an effective number of bits (ENOB) at action 628, then the corresponding corrective action may include re-configuring the component under test to operate at a lower resolution. For instance, the safety software 131 may include functionality to re-program the settings of the component under test at action 630. In other words, if a setting, such as sampling rate or resolution, is detected to cause a malfunction at a first level, then the safety software 131 may re-program the settings of the component under test to be lower.

Safety software 131 in this example may follow either or both of actions 624, 630 by moving to action 626. Action 626 may include generating an interrupt, by interrupt controller 203, to an appropriate one of (or all of) processor cores 102-104 and the DMA circuit 105. Then the appropriate one of (or all of) processor cores 102-104 and the DMA circuit 105 may respond to the interrupt by, e.g., changing software or firmware settings to accommodate the lower sampling rate and/or lower resolution.

Following actions 624 and 630, the safety software 131 may then move to action 616, 608, 610, and/or 606 (described above).

An advantage of some implementations is that the safety software 131 running on processor core 101 may perform methods 400, 500, and 600 during runtime of the main application 132 on processor core 102. Thus, in the example of system 100, the main application 132 does not compete for processing power with the safety software 131. Another advantage of some implementations is that some detected malfunctions may receive corrective action during runtime of the main application 132 on processor core 102, thereby allowing for continued operation and even increased longevity in some instances by avoiding scrapping system 100.

Additionally, while the examples of FIGS. 5-6 refer to corrective actions that may be taken with respect to RAM and an analog component, the scope of implementations may include any corrective action to be performed on a component in response to a BIST operation. For instance, in the case of a combinational logic circuit failing a BIST operation performed by logic BIST circuit 110, the safety software 131 may indicate unavailability of the combinational logic circuit. For instance, the safety software 131 may generate an interrupt. The interrupt may cause an appropriate one of (or all of) processor cores 102-104 and the DMA circuit 105 to operate in a limp mode.

The term “semiconductor die” is used herein. A semiconductor device can be a discrete semiconductor device such as a bipolar transistor, a few discrete devices such as a pair of power FET switches fabricated together on a single semiconductor die, or a semiconductor die can be an integrated circuit with multiple semiconductor devices such as the multiple capacitors in an ADC. The semiconductor device can include passive devices (such as resistors, inductors, and filters), sensors, and/or active devices such as transistors. The semiconductor device can be an integrated circuit with hundreds or thousands of transistors coupled to form a functional circuit, for example a microprocessor or memory device. The semiconductor device may also be referred to herein as a semiconductor device or an integrated circuit (IC) die.

The term “semiconductor package” is used herein. A semiconductor package has at least one semiconductor die electrically coupled to terminals and has a package body that protects and covers the semiconductor die. In some arrangements, multiple semiconductor dies can be packaged together. For example, a power metal oxide semiconductor (MOS) field effect transistor (FET) semiconductor device and a second semiconductor device (such as a gate driver die, or a controller die) can be packaged together to from a single packaged electronic device. Additional components such as passive components, such as capacitors, resistors, and inductors or coils, can be included in the packaged electronic device. The semiconductor die is mounted with a package substrate that provides conductive leads. A portion of the conductive leads form the terminals for the packaged device. In wire bonded integrated circuit packages, bond wires couple conductive leads of a package substrate to bond pads on the semiconductor die. The semiconductor die can be mounted to the package substrate with a device side surface facing away from the substrate and a backside surface facing and mounted to a die pad of the package substrate. The semiconductor package can have a package body formed by a thermoset epoxy resin mold compound in a molding process, or by the use of epoxy, plastics, or resins that are liquid at room temperature and are subsequently cured. The package body may provide a hermetic package for the packaged device. The package body may be formed in a mold using an encapsulation process, however, a portion of the leads of the package substrate are not covered during encapsulation, these exposed lead portions form the terminals for the semiconductor package. The semiconductor package may also be referred to as a “integrated circuit package,” a “microelectronic device package,” or a “semiconductor device package.”

While various examples of the present disclosure have been described above, it should be understood that they have been presented by way of example only and not limitation. Numerous changes to the disclosed examples can be made in accordance with the disclosure herein without departing from the spirit or scope of the disclosure. Modifications are possible in the described embodiments, and other embodiments are possible, within the scope of the claims. Thus, the breadth and scope of the present invention should not be limited by any of the examples described above. Rather, the scope of the disclosure should be defined in accordance with the following claims and their equivalents.

What is claimed is:

1. A method comprising:
executing computer-executable code for a first application, wherein the first application includes receiving data from a hardware component of a computer system on which the first application runs;
concurrent with the executing of the computer-executable code for the first application, executing computer-executable code for a second application that causes a built-in self-test (BIST) operation to run on the hardware component; and
performing, by the second application and during runtime of the first application, a corrective action upon the hardware component based on results of the BIST operation.

2. The method of claim 1, wherein receiving data from the hardware component includes performing a read operation on a random-access memory (RAM) circuit.

3. The method of claim 2, wherein performing the corrective action includes:
configuring an address translation circuit of a processor core configured to run the first application, wherein configuring the address translation circuit includes causing the address translation circuit to translate an address in the read operation based upon the BIST operation.

4. The method of claim 1, wherein receiving data from the hardware component includes receiving data from an analog-to-digital converter (ADC).

5. The method of claim 4, wherein performing the corrective action includes:
trimming a capacitor of the ADC based upon a result of the BIST operation.

6. The method of claim 4, wherein performing the corrective action includes:
causing the ADC to operate at a sampling rate lower than a sampling rate indicated by the BIST operation to cause a malfunction and transmitting an interrupt signal to a processor core running the first application to indicate the corrective action.

7. The method of claim 4, wherein performing the corrective action includes:
causing the ADC to operate at a resolution lower than a resolution indicated by the BIST operation to cause a malfunction and transmitting an interrupt signal to a processor core running the first application to indicate the corrective action.

8. The method of claim 1, wherein performing the corrective action includes: transmitting an interrupt signal to a processor core running the first application to indicate a limp mode of operation of the first application.

9. A system comprising:
a first processor core;
a second processor core; and
an address translation circuit, coupled between the second processor core and a memory circuit, wherein the address translation circuit is configured to translate addresses of the memory circuit in transactions from the second processor core;
wherein the first processor core is configured to change a setting of the address translation circuit, via a hardware signal, to configure translation of addresses by the address translation circuit during runtime of an application by the second processor core.

10. The system of claim 9, further comprising:
an access management circuit, coupled to the first processor core and to the second processor core, wherein the access management circuit is configured to grant access to the first processor core to change the setting of the address translation circuit.

11. The system of claim 9, wherein the first processor core comprises a dual-core lockstep component.

12. The system of claim 9, further comprising:
an interconnect, configured to couple the second processor core to the memory circuit, wherein the second processor core is configured to access the memory circuit, for the transactions from the second processor core, via the interconnect, further wherein the first processor core is configured to transmit the hardware signal on a conductor separate from the interconnect.

13. The system of claim 9, wherein the first processor core is configured to: execute computer-executable code to cause the first processor core to cause a test to run on the memory circuit, receive a result of the test, and to change the setting of the address translation circuit in response to the result of the test.

14. The system of claim 9, wherein the second processor core is configured to run the application, and wherein the application is associated with the transactions from the second processor core, further wherein the first processor core is configured to run another application that causes the first processor core to change the setting of the address translation circuit via the hardware signal, further wherein runtime of the application overlaps with runtime of the another application.

15. The system of claim 14, wherein the first processor core includes a tightly coupled memory circuit, wherein the tightly coupled memory circuit is configured to store computer-executable code of the another application, and wherein the second processor core is configured to load the computer-executable code to the tightly coupled memory circuit during boot up of the system.

16. An integrated circuit (IC) comprising:
a first processor core;
a second processor core;
a hardware module coupled to the first processor core and configured to transmit data to the first processor core during runtime of a first application, which is run on the first processor core; and
a tightly coupled memory (TCM) circuit, disposed within the second processor core and configured to store computer-executable code for built-in self-test (BIST) management software, wherein the BIST management software is configured to cause a BIST operation to run on the hardware module during runtime of the first application.

17. The IC of claim 16, wherein the TCM circuit is further configured to store computer-executable code for performing corrective actions on the hardware module, in response to the BIST operation, and during runtime of the first application.

18. The IC of claim 17, wherein the hardware module comprises an analog-to-digital converter (ADC), and wherein the computer-executable code for performing the corrective actions include computer-executable code to perform a calibration operation or a trimming operation on the ADC.

19. The IC of claim 17, wherein the hardware module comprises an analog-to-digital converter (ADC), and wherein the computer-executable code for performing the corrective actions include computer-executable code to reduce a resolution or a sampling rate of the ADC.

20. The IC of claim 17, wherein the hardware module comprises a random-access memory (RAM) circuit, and wherein the first processor core includes a real-time address translation circuit configured to translate an address within the RAM circuit for transactions from the RAM circuit, and wherein the computer-executable code for performing the corrective actions include computer-executable code to configure the real-time address translation circuit.
